(19) United States
(12) Patent Application Publication
(10) Pub. No.: US 2020/0037581 A1
(43) Pub. Date: Feb. 6, 2020

(54) Animal Restraint System

(71) Applicant: Trailblazing Tails, Inc., Portland, OR (US)

(72) Inventor: Tricia A. Case, Portland, OR (US)

(21) Appl. No.: 16/597,766

(22) Filed: Oct. 9, 2019

Related U.S. Application Data
(63) Continuation-in-part of application No. 15/632,255, filed on Jun. 23, 2017.

(51) Int. Cl. A01K 27/00

(52) U.S. Cl. CPC A01K 27/003

(57) ABSTRACT

A system for restraining an animal, comprising a strap having a first end and a second end with respective connectors fixed to the first end and the second end; and a connection point slidably coupled to the strap, the connector fixed on the first or second end removably coupled to the connection point.

### CROSS-REFERENCE TO RELATED APPLICATIONS

This patent application is a continuation-in-part of, and claims priority to, U.S. patent application Ser. No. 15/632,255, filed Jun. 23, 2017, entitled “Animal Restraint System”, the contents of which are incorporated herein by reference.

### TECHNICAL FIELD

Embodiments of the present invention relate to an animal restraint system involving an arrangement of leashes, and in particular, to a system that an individual can use to better control multiple animals.

### BACKGROUND

An individual may need to control multiple animals simultaneously, for example, a person walking, or running, with multiple dogs. Often times, for reasons of safety and control, the individual will connect a leash to a collar, harness or halter on each animal. The individual may hold on to a separate leash with each hand, and if more than two animals are involved, there may be multiple leashes held in one or both hands. Depending on varying physical characteristics and behavioral patterns of the animals, it may become unwieldy to control, or separate, the animals, as needed or desired. What is needed is a system that allows for quick, efficient, and effective control of each animal.

### BRIEF DESCRIPTION OF THE DRAWINGS

Embodiments are illustrated by way of example, and not by way of limitation, and can be more fully understood with reference to the following detailed description when considered in connection with the figures in which:

FIG. 1 illustrates a component of an embodiment of the invention.

FIGS. 2A, 2B and 2C illustrate embodiments of the invention.

FIGS. 3A and 3B illustrate an embodiment of the invention.

FIGS. 4A and 4B illustrate an embodiment of the invention.

FIGS. 5A and 5B illustrate an embodiment of the invention.

### DETAILED DESCRIPTION

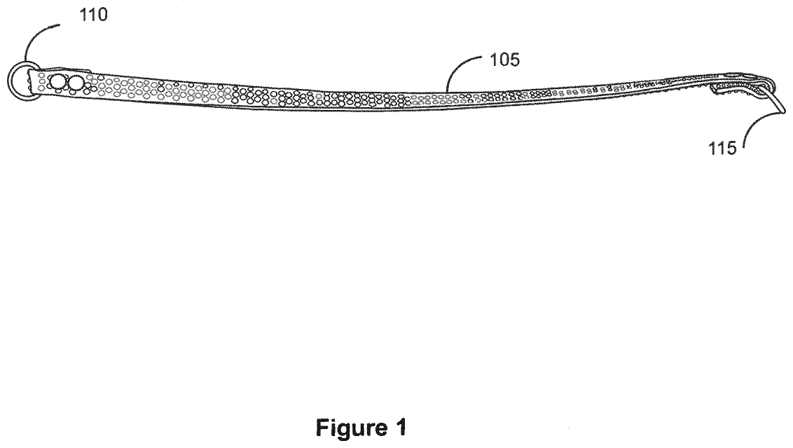

FIG. 1 illustrates a handle 105 that is a strap, according to one embodiment of the invention. The strap has a first end and a second end. A connection point 110 is fixed to the first end, and a second connection point 115 is fixed to the second end. In one embodiment, the connection points fixed to the first end and the second end of the strap may be an O-shaped ring, a D-shaped ring, a rectangle-shaped ring, a square-shaped ring, or a triangle-shaped purse strap connection point. In one embodiment, the length of the strap is approximately equal to or greater than an average individual's shoulder width so that an individual can grasp with one hand the handle 105 near, or just inside, the connection point 110, i.e., at the first end, and grasp with the other hand the handle 105 near, or just inside, the connection point 115, i.e., at the second end. With the handle grasped so in both hands and held in a substantially horizontal position, the individual can hold their hands at approximately shoulder width and near their hips, while standing, walking, or even running upright, all the while optionally keeping slight tension on the handle 105, and independently control the position or orientation of, and tension on, at least a first leash connected to connection point 110 and a second leash connected to connection point 115.

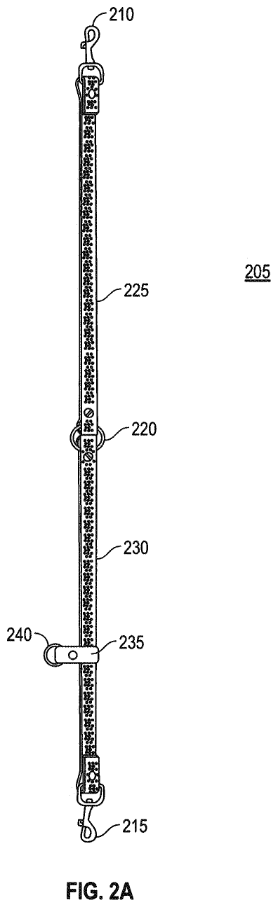

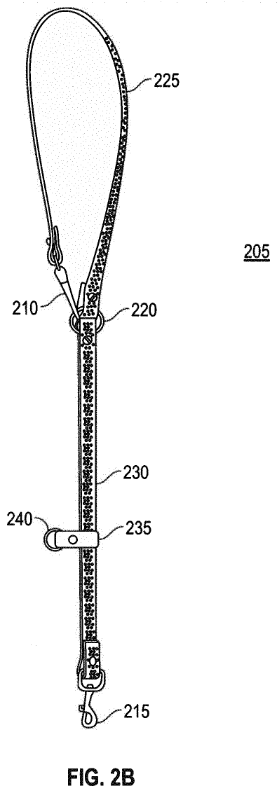

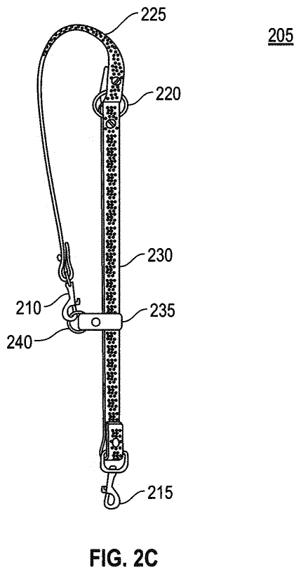

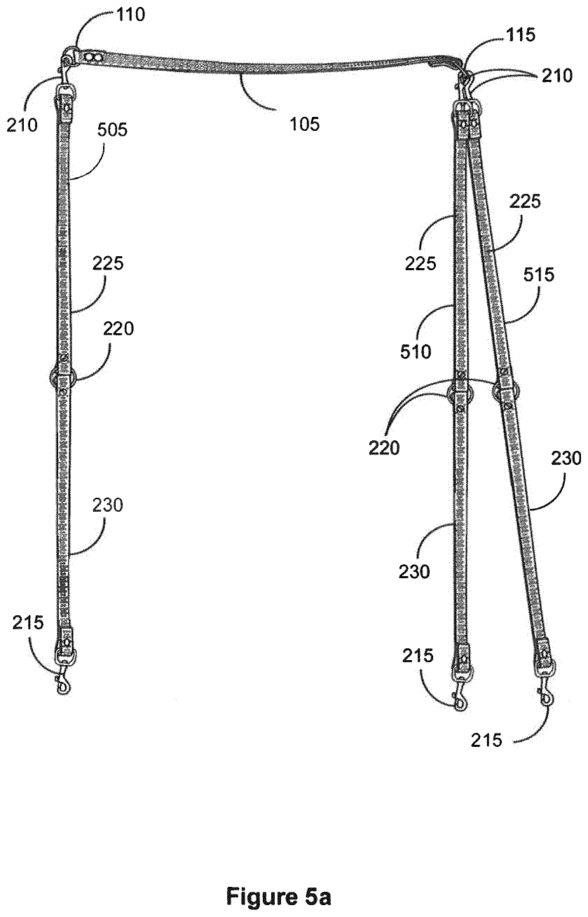

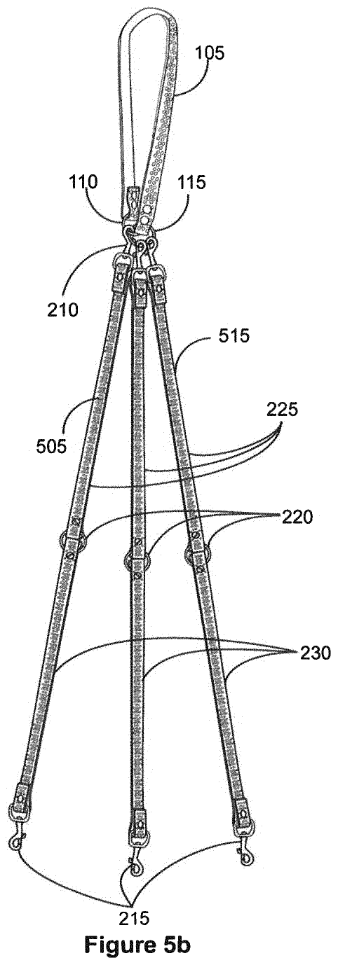

FIG. 5A illustrates an embodiment of the invention in which the handle 105 is connected at connection point 110 to a first leash 505, and connected at connection point 115 to a second leash 510. FIG. 2A illustrates such a leash 505, 510 according to one embodiment 205. The leash, too, is a strap. The strap has a first end with a first connector 210 that allows the leash 205 to be connected to or disconnected from handle 105 at connection points 110 and/or 115. The strap has a second end with a second connector 215 that allows the leash to be connected to or disconnected from an animal's collar, harness, halter, muzzle, or the like. In one embodiment, the connector is a bolt snap. In an alternative embodiment, the connector is a trigger snap, or a hook snap, or other type of connector in which it is relatively quick and easy for an individual to connect and disconnect the leash 205 to/from the handle 105.

In the embodiment illustrated in FIG. 5A, the handle 105 is further connected at connection point 115 to a third leash 515. Indeed, it is appreciated that multiple additional leashes can be connected to or disconnected from the handle 105 at connection points 110 and/or 115. There may be an instance, for example, in which a leash connected to connection point 110 is disconnected and reconnected to the handle at connection point 115, such as when multiple animals are leashed with leashes connected at connection point 110 and one of those animals is presenting physical or behavioral issues that suggests the need to separate it from the other animals leashed with leashes connected at connection point 110 by disconnecting its leash from connection point 110 and reconnecting the leash to connection point 115 on the other side of handle 105.

Alternatively, in one embodiment, with references to FIGS. 2A and 5B, handle 105 can be formed into a loop by connecting connector 210 of leash 505 to both connection point 110 and connection point 115. One or more additional leashes, such as leashes 510 and 515 may also be connected to either or both of connection point 110 and connection point 115. In any case, an individual is now able to grasp the handle 105 in either hand or with both hands and control the position or orientation of, and tension on, those leashes connected to connection point 110 and/or connection point 115.

When handle 105 is formed into a loop as described above, there may be an instance in which those leashes with their respective connector 210 connected to both connection point 110 and connection point 115 are disconnected from one or the other connection point so that each leash is at most connected to a single connection point, either connection point 110 or connection point 115. Then the handle 105 no longer forms a loop, and a leash connected to connection point 110 can be disconnected and reconnected to the handle at connection point 115, such as when multiple animals are leashed with leashes connected at connection point 110 and one of those animals is presenting physical or behavioral issues that suggests the need to separate it from the other animals leashed with leashes connected at connection point 110 by disconnecting its leash from connection point 110 and reconnecting the leash to connection point 115 on the other side of handle 105.

With reference to FIGS. 2B and 5A, a leash 205/505 connected by connector 210 to connection point 110 or 115 of handle 105 can be disconnected, separating the leash 205/505 from the handle 105. The leash 205/505 has a connection point 220 located at or around the midpoint of the leash, in one embodiment. In another embodiment, the connector may be at a location on either side of the midpoint of the leash. In any case, the connector 210, having been disconnected from connection point 110 or 115 of handle 105 can now be connected to the connection point 220, thereby forming a loop in leash 205/505 that can be used as a handle to be grasped by hand or be used as a means for otherwise securing, e.g., wrapping, the leash 205/505 to or around an object, such as a post or other fixed or sufficiently heavy object, so that an animal on the leash by means of the second connector 215 that allows the leash to be connected to the animal's collar, harness, halter, muzzle, or the like, can be independently controlled or segregated from other animals whose leashes are connected to handle 105.

The connection point 220 in one embodiment, as illustrated in FIGS. 2A and 2B, is located in a fixed position on leash 205, substantially at a midpoint of leash 205, wherein leash 205 comprises a first portion or segment of strap 225 and a second portion or segment of strap 230. In this embodiment, the first segment and second segments are necessarily of substantially equal length. However, in other embodiments, one segment may be longer, even substantially so, than the other segment. In any case, the strap segments 225 and 230 are connected together by virtue of each having the connection point 220 fixed to a respective end thereof. In such an embodiment, the connection point may be, for example, an O-shaped ring, a D-shaped ring, a rectangle-shaped ring, a square-shaped ring, a triangle-shaped purse strap connection point, or the like. Similarly, the strap segments may overlap a small amount, e.g., an inch or two, and be fixed to one another via a connection means, such as one or more rivets.

In one embodiment, with reference to FIGS. 2A-2C, a loop of strap, or tab, 235 is slidably coupled to the strap segment 230. Given the tab 235 is slidably coupled to strap segment 230, it can be moved by hand to any point along strap segment 230 between connection point 220 and connector 215. In one embodiment, the loop or tab 235 is sufficiently small as to encompass strap 230 and still be able to be slid easily by hand along strap 230, but not so large as to be able to be removed from strap 230 by sliding the tab over connection point 220 or connector 215. A connection point 240 is fixed to tab 235. In such an embodiment, the connection point may be, for example, an O-shaped ring, a D-shaped ring, a rectangle-shaped ring, a square-shaped ring, a triangle-shaped purse strap connection point, or the like.

Connector 210 is illustrated connected to connection point 220 in FIG. 2B, forming a loop in strap segment 225 so that, for example, a person can hold on to strap segment 225, as a handle. With reference to FIG. 2C, connector 210 can be disconnected from connection point 220 and alternatively connected to the connection point 240, thereby forming a loop of variable size in strap segments 225 and 230, given that tab 235 can slide anywhere along strap segment 230 from or near one end at connection point 220 to or near the other end at connector 215. This larger loop can be placed over a person's shoulder, their neck and shoulder, around their waist, or around an object, such as a fence post or rail, a small tree, or other fixed or sufficiently heavy object, thereby wrapping the leash formed by the combination of strap segments 225 and 230 to or around the person or object. In this way, an animal on the leash by means of the second connector 215 that connects the leash to the animal's collar, harness, halter, muzzle, or the like, can be controlled by means other than a hand or arm placed on, around, or in the loop formed by connector 210 connected to connection point 220. Because connection point 240 is coupled to slidably coupled tab 235, the loop formed by attaching connector 210 to connection point 240 can vary in size, allowing for the loop to be placed around persons or objects of varying dimensions, which provides great flexibility for the person using leash 205 to restrain an animal.

In another embodiment, a leash may comprise a single strap segment 230, but with connectors on either end, rather than a connection point 220 on one end and a connector 215 on the other end. In this embodiment, there may be a connection point fixedly coupled to the strap, or not. For example, consider a leash set up similar to that illustrated in FIG. 2A, but comprising a single strap and no connection point 220 fixed at a midpoint or thereabout. Such a leash comprises a single strap with connectors 210 and 215 on respective ends. The tab 235 in such an embodiment can slide anywhere along strap from or near one end at connector 210 to or near the other end at connector 215.

In an alternative embodiment, the connection point is removably coupled to one or both of the first and second segments. For example, each or both segment is connected to a buckle or set (e.g., a pair) of O-shaped rings or D-shaped rings through and/or around which respective ends of the segments are threaded and unthreaded or otherwise fixed.

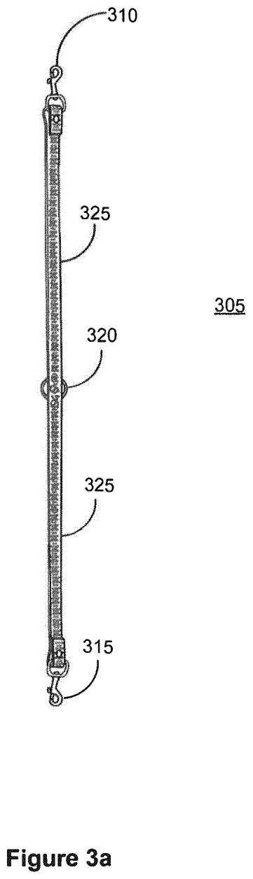

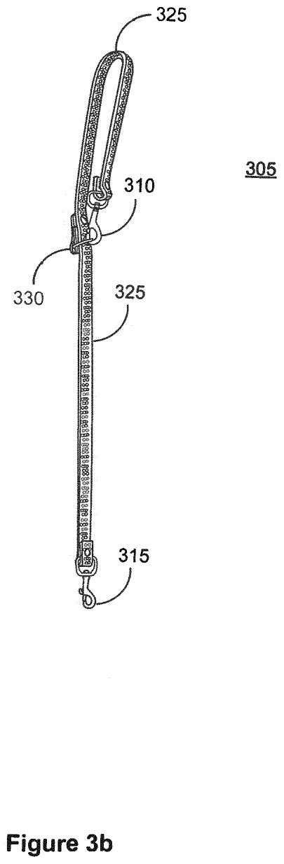

As described above, FIG. 5A illustrates an embodiment of the invention in which the handle 105 is connected at connection point 110 to a first leash 505, and connected at connection point 115 to a second leash 510. FIG. 3A illustrates such a leash 505, 510 according to one embodiment 305. The leash, too, is a strap. The strap has a first end with a first connector 310 that allows the leash 305 to be connected to or disconnected from handle 105 at connection points 110 and/or 115. The strap has a second end with a second connector 315 that allows the leash to be connected to or disconnected from an animal's collar, harness, halter, muzzle, or the like. In one embodiment, the connector is a bolt snap. In an alternative embodiment, the connector is a trigger snap, or a hook snap, or other type of connector in which it is relatively quick and easy for an individual to connect and disconnect the leash 305 to/from the handle 105.

With reference to FIGS. 3A, 3B and 5A, a leash 305 connected by connector 310 to connection point 110 or 115 of handle 105 can be disconnected, separating the leash 305 from the handle 105. The leash 305 has a connection point 320 located at or around the midpoint of the leash 305, in one embodiment. In another embodiment, the connector may be at a location on either side of the midpoint of the leash 305. In any case, the connector 310, having been disconnected from connection point 110 or 115 of handle 105 can now be connected to the connection point 320, thereby forming a loop in leash 305 that can be used as a handle to be grasped by hand or be used as a means for otherwise securing, e.g., wrapping, the leash 305 to or around an object, such as a post or other fixed or sufficiently heavy object, so that an animal on the leash by means of the second connector 315 that allows the leash to be connected to the animal's collar, harness, halter, muzzle, or the like, can be independently controlled or segregated from other animals whose leashes are connected to handle 105

The connection point 320 in one embodiment, as illustrated in FIGS. 3A and 3B, is located in a fixed position on leash 305, substantially at a midpoint of leash 305, wherein leash 305 comprises a single strap segment 325. However, in other embodiments, connection point 320 is located in a fixed position on leash 305 at some point other than the midpoint of leash 305. In any case, the connection point 320 is fixed to segment 325. In such an embodiment, the connection point may be, for example, an O-shaped ring, a D-shaped ring, a rectangle-shaped ring, a square-shaped ring, a triangle-shaped purse strap connection point, or the like. The connection point, according to one embodiment, further comprises a short segment of strap material 330 inserted through the connection point, doubled back upon itself, and held thereto via a holding means, as described below, to create a loop through which the connection point is fixed to the segment 325.

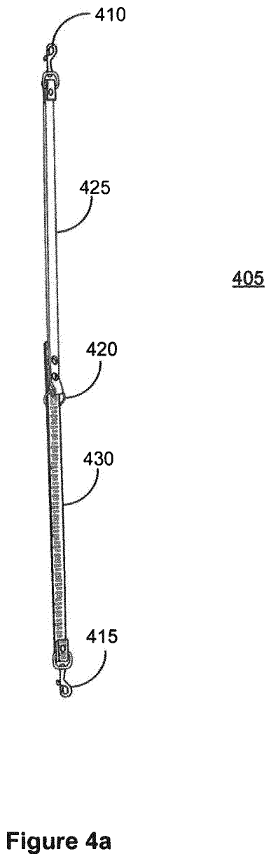

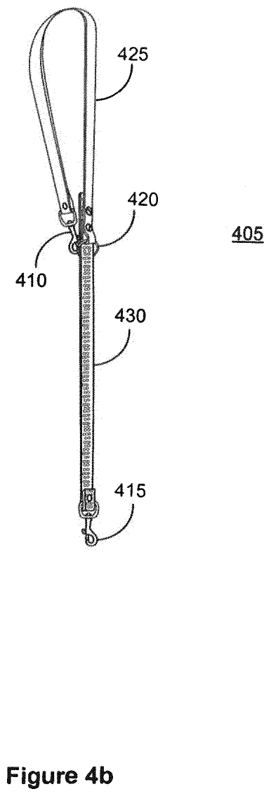

FIG. 4A illustrates a leash according to one embodiment 405. The leash, too, is a strap. With further reference to FIG. 1, the strap has a first end with a first connector 410 that allows the leash 405 to be connected to or disconnected from handle 105 at connection points 110 and/or 115. The strap has a second end with a second connector 415 that allows the leash to be connected to or disconnected from an animal's collar, harness, halter, muzzle, or the like. In one embodiment, the connector is a bolt snap. In an alternative embodiment, the connector is a trigger snap, or a hook snap, or other type of connector in which it is relatively quick and easy for an individual to connect and disconnect the leash 405 to/from the handle 105.

With reference to FIGS. 4B and 5A, a leash 405 connected by connector 410 to connection point 110 or 115 of handle 105 can be disconnected, separating the leash 405 from the handle 105. The leash 405 has a connection point 420 located at or around the midpoint of the leash 405, in one embodiment. In another embodiment, the connector may be at a location on either side of the midpoint of the leash 405. In any case, the connector 410, having been disconnected from connection point 110 or 115 of handle 105 can now be connected to the connection point 420, thereby forming a loop in leash 405 that can be used as a handle to be grasped by hand or be used as a means for otherwise securing, e.g., wrapping, the leash 405 to or around an object, such as a post or other fixed or sufficiently heavy object, so that an animal on the leash by means of the second connector 415 that allows the leash to be connected to the animal's collar, harness, halter, muzzle, or the like, can be independently controlled or segregated from other animals whose leashes are connected to handle 105.

The connection point 420 in one embodiment, as illustrated in FIGS. 4A and 4B, is located in a fixed position on leash 405, substantially at a midpoint of leash 405, wherein leash 405 comprises a first portion or segment 425 and a second portion or segment 430. In this embodiment, the first segment and second segments are necessarily of substantially equal length. However, in other embodiments, one segment may be longer, even substantially so, than the other segment. In any case, the segments 425 and 430 are connected where their ends overlap and are held together via a holding means, as described below. Connection point 420 is fixed to one of the ends, and passes through the other end, in one embodiment. In such an embodiment, the connection point may be, for example, an O-shaped ring, a D-shaped ring, a rectangle-shaped ring, a square-shaped ring, a triangle-shaped purse strap connection point, or the like.

In each of the above described embodiments, an end of a strap, whether the first or second ends of the handle 105 or first or second ends of leash 205, or a short segment of strap, e.g., strap 330, or where segments 425 and 430 of leash 405 overlap, is connected to connection point, or each other, as the case may be, by various holding means. For example, a strap end or strap segment may be looped around the connection point or connector, as the case may be, doubled back onto itself, and held into place to create a loop that fixes the connection point or connector in position. The doubled-back portion of the strap may be held in place by one or more rivets, clamps, Chicago screws, barrel nuts, or post and screws that secure the doubled back portion of the strap to the strap itself. Alternatively, heat or a chemical weld or bond, or sewed stitching, may hold the doubled back portion of the strap to the strap itself. In various embodiments, combinations of the above described hardware or attachment methods may be used.

In one embodiment the doubled-back portion of the strap may be sufficiently long, and held in place by two securing elements, such as rivets, spaced sufficiently far apart to create a small space between the doubled back portion of the strap and the strap itself, when pulled apart, and in which to insert or wedge an object, such as a small disposable plastic bag, until such time as one pulls sufficiently hard on the object to remove it from the grasp of the doubled back portion of the strap and the strap itself.

In each of the above described embodiments, the material out of which a strap is made may be flat nylon webbing, leather, rubber, urethane coated webbing, vinyl coated webbing, polyester webbing, a flexible substrate core bonded with thermoplastic polyurethane alloy coated webbing, a flexible substrate core bonded with a plastic polymer, and a flexible substrate core bonded with polyvinyl chloride.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims that follow. Features of the disclosed embodiments can be combined and rearranged in various ways.

What is claimed is:

1. An apparatus for restraining an animal, comprising:
a strap having a first end and a second end with respective connectors fixed to the first end and the second end; and
a connection point slidably coupled to the strap, the connector fixed on the first or second end removably coupled to the connection point.

2. The apparatus of claim 1, further comprising a loop coupled to the connection point and the strap, by which the connection point is slidably coupled to the strap.

3. The apparatus of claim 1, wherein the connection point slidably coupled to the strap is selected from a group of connection points consisting of an O-shaped ring, a D-shaped ring, a rectangle-shaped ring, a square-shaped ring, and a triangle-shaped purse strap connection point.

4. The apparatus of claim 1, wherein the first end and the second end of the strap are inserted through the respective connectors at the first end and the second end of the strap, doubled back upon the strap, and held thereto via a holding means to create a loop through which the connectors at the first end and the second end of the strap are fixed to the respective strap.

5. The apparatus of claim 4, wherein the holding means is selected from a group of: one or more rivets, clamps, Chicago screws, barrel nuts, post and screws, heat or chemical weld or bond, and sewed stitching, and combinations thereof.

6. The apparatus of claim 1, wherein the connectors fixed to the first end and the second end of the strap are selected from a group of connectors consisting of: a bolt snap, a trigger snap, and a hook snap.

7. The apparatus of claim 2, wherein the strap and the loop is selected from a group of materials consisting of: flat nylon webbing, leather, rubber, urethane coated webbing, vinyl coated webbing, polyester webbing, a flexible substrate core bonded with thermoplastic polyurethane alloy coated webbing, a flexible substrate core bonded with a plastic polymer, and a flexible substrate core bonded with polyvinyl chloride.
